(19) United States
(12) Patent Application Publication
(10) Pub. No.: US 2018/0311996 A1
(43) Pub. Date: Nov. 1, 2018

(54) METHOD OF FORMING 3-DIMENSIONAL PATTERNS ON WORKPIECE AND HEAT TRANSFER FILM

(71) Applicant: HON HAI PRECISION INDUSTRY CO., LTD., New Taipei (TW)

(72) Inventors: JIH-CHEN LIU, New Taipei (TW); HUNG-CHUN MA, New Taipei (TW); CHIH-JUNG CHANG, New Taipei (TW); WEI-TING CHEN, New Taipei (TW); YU-LIN LIAO, New Taipei (TW); CHEN-CHU CHIANG, New Taipei (TW); HAN-LUNG LEE, New Taipei (TW); JAN-WAN CHANG, New Taipei (TW); HAN-LUNG CHAO, New Taipei (TW)

(21) Appl. No.: 15/643,829

(22) Filed: Jul. 7, 2017

(30) Foreign Application Priority Data
Apr. 27, 2017 (TW) 106114018

(51) Int. Cl. B44C 1/17; B05D 3/06; B05D 1/28

(52) U.S. Cl. CPC B44C 1/1716; B05D 1/28; B05D 3/062

(57) ABSTRACT

A method of fabricating three-dimensional patterns on a workpiece includes steps of providing a transparent film and forming a three-dimensional patterns on the transparent film. A layer of adhesive is coated on the three-dimensional patterns. A heat transfer film is used in transferring the three-dimensional patterns from the heat transfer film to a main surface of the workpiece using a vacuum heat transfer printing method.

The subject matter herein generally relates to a method for manufacturing 3-dimensional patterns on workpiece and heat transfer film.

### BACKGROUND

In order to increase an overall aesthetic design of electronic devices, and to attract attention of consumers, various patterns are formed on the shell of electronic devices. According to conventional methods, patterns are formed on metal shells or shell resins, using paint, where the patterns are two-dimensional, and the paint can be an environmental pollutant.

### BRIEF DESCRIPTION OF THE DRAWINGS

Implementations of the present technology will now be described, by way of example only, with reference to the attached figures.

FIG. 1 is a flowchart of a method for manufacturing 3-dimensional patterns on workpiece in accordance with an exemplary first embodiment.

FIG. 2 is a cross section view along a heat transfer film of the method of FIG. 1 in accordance with an exemplary second embodiment.

FIGS. 3-7 are isometric views of a heat transfer machine of the method of FIG. 1, for manufacturing 3-dimensional patterns on workpieces.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

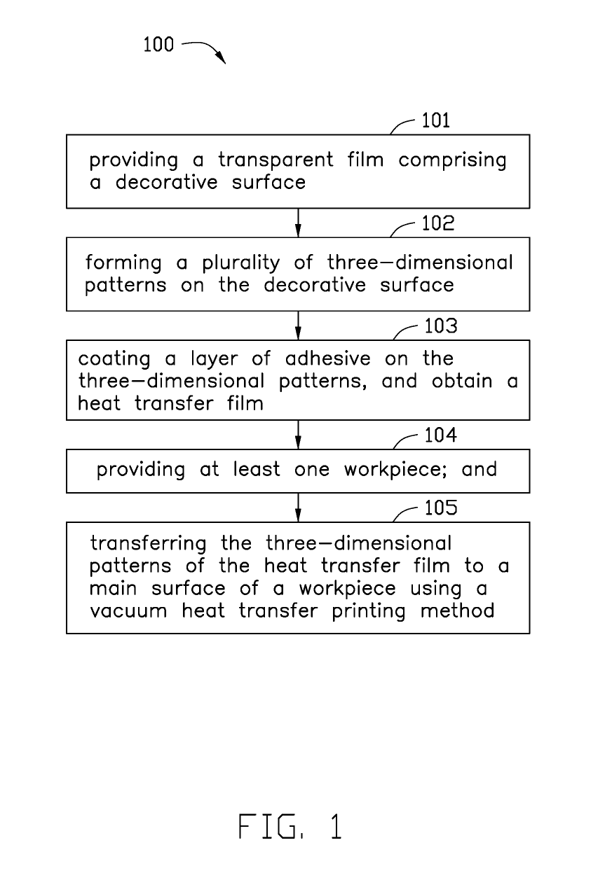

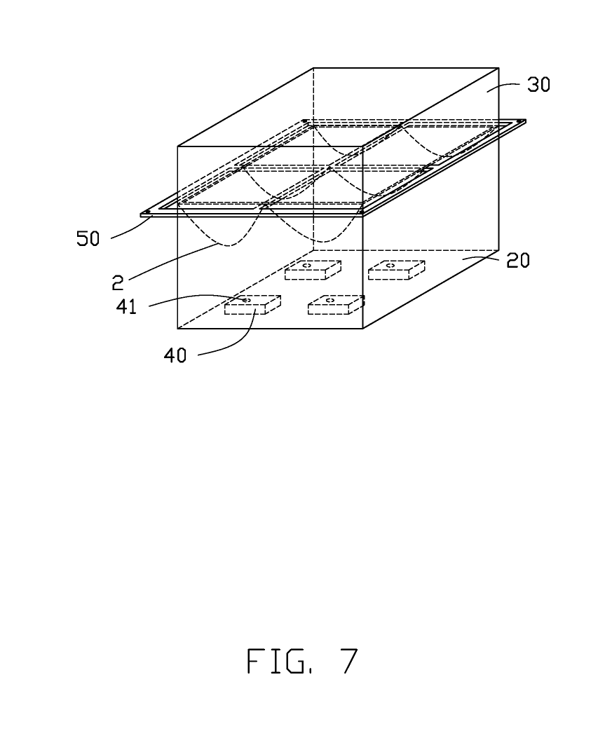

FIG. 1 illustrates a flowchart of a method in accordance with an exemplary embodiment. The exemplary method 100 for manufacturing 3-dimensional patterns on a workpiece (shown in FIG. 7) is provided by way of example, as there are a variety of ways to carry out the method. Additionally, the illustrated order of blocks is by way of example only and the order of the blocks can change or blocks can be omitted. The method 100 can begin at block 101.

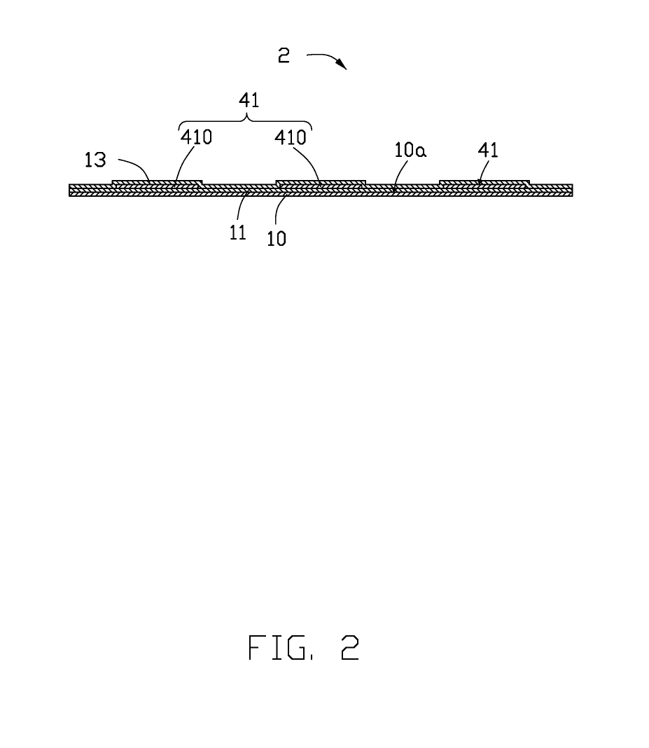

At block 101, a transparent film 10 is provided, as shown in FIG. 2. A material of the transparent film 10 is polyolefin. The transparent film 10 comprises a decorative surface 10a.

At block 102, a hard coating film 11 is formed on the decorative surface 10a of the transparent film 10. The hard coating film 11 is configured to increase a strength of the transparent film 10. The composition of the hard coating film 11 may include polyurethane resin, epoxy resin, acrylic resin, polyether resin, polyamide resin, poly cellulose acetate resin, and any combination thereof. In an alternative embodiment, the hard coating film 11 is also can be a removable adhesive tape.

At block 103, a plurality of three-dimensional patterns 410 is formed on the hard coating film 11, and a pattern layer 41 is formed on the hard coating film 11. In the exemplary embodiment, the three-dimensional patterns 410 are formed using a jet printing method. The jet printing method may comprise the following steps:

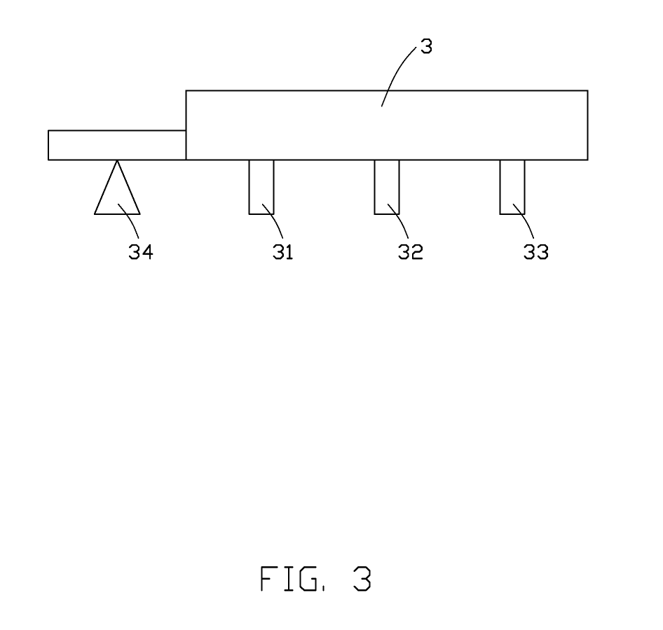

First, an UV (ultraviolet) inkjet printer 3 is provided. As shown in FIG. 3, the UV inkjet printer 3 includes a first inkjet head 31, a second inkjet head 32, a third inkjet head 33 and a UV light source 34. The first inkjet 31 is configured to inkjet UV-curable adhesive, and the second inkjet head 32 and the third inkjet head 33 are configured to inkjet colorful UV-curable ink, and the UV light source 34 is configured to cure the UV-curable adhesive and the colorful UV-curable ink.

Second, a UV curable ink is inkjeted on the hard coating film 11 using the UV ink jet printer 3. The UV curable ink contains no volatile organic compounds (VOC), as compared to solvent based inks. The UV curable ink can dry faster under UV light source 34, and has non irritating odor, thus is environmentally friendly.

Third, the UV curable ink is cured with UV light source 34 using the UV inkjet printer 3, and then a pattern layer 41 is formed on the hard coating film 11.

At block 104, an adhesive layer 13 is formed on the pattern layer 41, and a heat transfer film 2 is obtained. In the exemplary embodiment, a material of the adhesive layer 13 is UV-curable adhesive and the UV-curable adhesive is colorless and transparent.

At block 105, the three-dimensional patterns 410 of the heat transfer film are transferred to a main surface of a workpiece, for example, using a vacuum heat transfer printing method. The vacuum heat transfer printing method may comprise the following steps:

First, a heat transfer machine 1 is provided, as shown in FIGS. The heat transfer machine 1 comprises a lower mold 20 and an upper mold 30. The lower mold 20 comprises a mold cavity 201. In this embodiment, a positioning frame 50 is also provided and the heat transfer film 2 is fixed on the positioning frame 50.

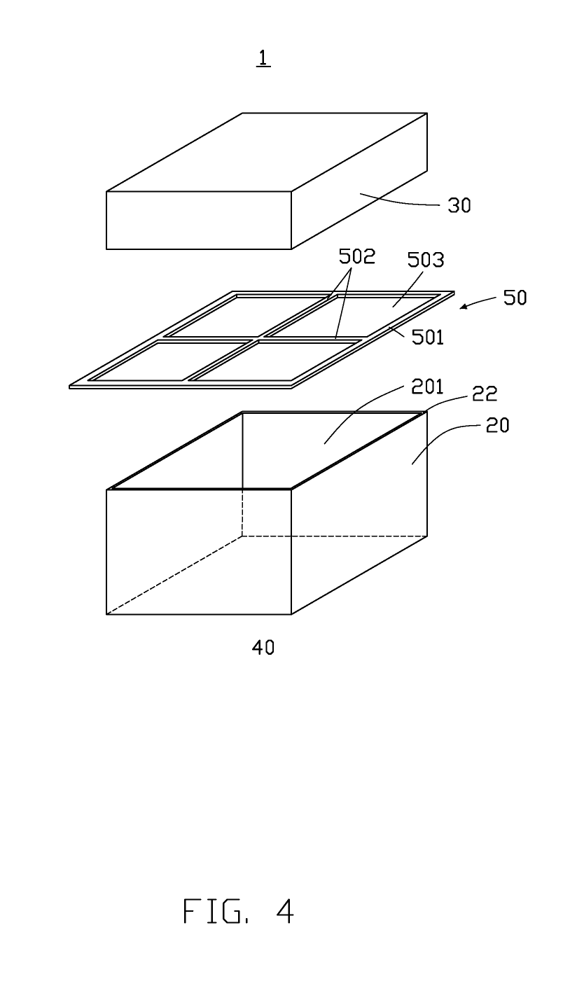

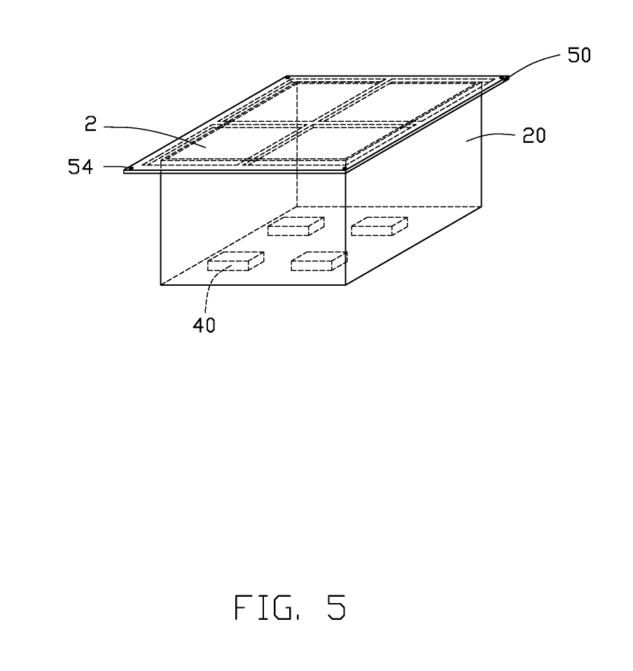

The positioning frame 50 is substantially square-shaped and has a size slightly larger than a top opening 22 of the lower mold 20, as shown in FIG. 4. The positioning frame 50 comprises a surrounding frame 501 and a plurality of ribs 502, the plurality of ribs 502 are intercrossed, and each ribs 502 comprises two opposite ends, and the two ends of each rib 502 are connected with the surrounding frame 501. In the exemplary embodiment, the two ribs 502 are perpendicularly to each other. And a plurality of hollow areas 503 are formed by the intercrossed ribs 502.

The positioning frame 50 is divided into a plurality of hollow areas 503 by the plurality of ribs 502. The heat transfer film 2 is fixed on the positioning frame 50 using fixing members 54. The fixing members can be adhesive tape, or screws. The heat transfer film 2 is divided into a plurality of heat transfer areas corresponding to the hollow areas 503, each transfer area contains at least one three-dimensional pattern 410, and each three-dimensional pattern 410 is corresponded to one workpiece 40. The number of the three-dimensional patterns 410 on the heat transfer film 2 can be determined according to the number of the workpieces 40, and each three-dimensional pattern 410 corresponds to a workpiece 40 received in the mold cavity 201.

Second, the workpieces 40 are disposed into the mold cavity 201 and the workpieces 40 are spaced apart from each other.

Third, the positioning frame 50 with the heat transfer film 2 is disposed on the lower mold 20 and the adhesive layer 13 of the heat transfer film 2 faces toward the main surface of the workpieces 40.

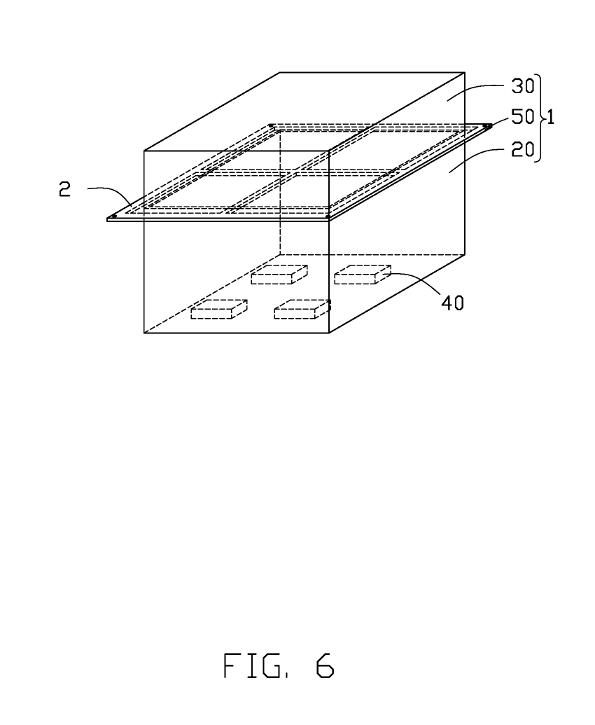

Fourth, the upper mold 30 covers the lower mold 20, as shown in FIG. 6, and the workpieces 40 and the heat transfer film 2 are located in a closed space formed by the upper mold 30 and the lower mold 20.

Fifth, the mold cavity 201 is heated (not shown) and a negative pressure is applied to the heat transfer machine 1. A positive pressure is applied above the heat transfer film 2. The heat transfer film 2 gradually softens, as shown in FIG. 7. The adhesive layer 13 is attached to the main surface of each of the workpieces 40, and the adhesive layer 13 is cured. The adhesive layer 13 is thus located between the main surface of each of the workpieces 40 and the pattern layer 41.

Finally, the hard coating film 11 and the transparent film 10 are removed from the workpieces 40, and the three-dimensional pattern 410 is formed on each of the workpieces 40.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method of fabricating three-dimensional patterns on a workpiece, the method comprising:
providing a transparent film comprising a decorative surface;
forming a plurality of three-dimensional patterns on the decorative surface;
coating a layer of adhesive on the three-dimensional patterns, and obtaining a heat transfer film;
providing at least one workpiece; and transferring the three-dimensional patterns of the heat transfer film to a main surface of the at least one workpiece using a vacuum heat transfer printing method.

2. The method of claim 1, wherein the vacuum heat transfer printing method comprises:
providing a heat transfer machine, the heat transfer machine comprising a lower mold and an upper mold, the lower mold comprising a mold cavity;
disposing the at least one workpiece into the mold cavity;
disposing the heat transfer film above the main surface of the at least one workpiece and the adhesive layer facing toward the main surface of the at least one workpiece;
covering the upper mold on the lower mold;
heating the mold cavity, the heat transfer film being turned soften and being attached to the main surface of the at least one workpiece;
and removing the heat transfer film.

3. The method of claim 2, wherein a material of the transparent film is polyolefin.

4. The method of claim 3, wherein before the step of forming a three-dimensional patterns on the transparent film, the method further comprises a step of forming a hard coating film on the decorative surface of the transparent film.

5. The method of claim 2, wherein providing a heat transfer machine further comprises providing a positioning frame, and the heat transfer film is fixed on the positioning frame.

6. The method of claim 5, wherein the positioning frame is substantially square-shaped.

7. The method of claim 6, wherein the positioning frame comprises a surrounding frame and a plurality of ribs, the plurality of ribs is intercrossed, and each of the plurality of ribs comprises two opposite ends, and the two opposite ends are connected with the surrounding frame.

8. The method of claim 1, wherein the positioning frame is divided into a plurality of hollow areas by the plurality of ribs, the heat transfer film is fixed on the positioning frame, the heat transfer film is divided into a plurality of heat transfer areas, each of the plurality of transfer areas contains at least one of the plurality of the three-dimensional patterns.

9. The method of claim 1, wherein the adhesive is UV curable adhesive or heat curable adhesive.

10. The method of claim 1, wherein the plurality of three-dimensional patterns is formed using a jet printing method.

11. The method of claim 10, wherein the jet printing method comprises:
inkjeting UV curable ink on the transparent film using a UV curable inkjet printer;
and curing the UV curable ink with ultraviolet light.

12. A heat transfer film, comprising:
a transparent film;
a pattern layer being formed on the transparent film;
wherein the pattern layer is made from UV curable ink.

13. The heat transfer film of claim 12, wherein the heat transfer film further comprises an adhesive layer formed on the pattern layer.

14. The heat transfer film of claim 12, wherein a material of the transparent film is polyolefin.

15. The heat transfer film of claim 12, wherein the heat transfer film further comprises a hard coating film, and the hard coating film is formed between the transparent film and the pattern layer.

16. The heat transfer film of claim 13, wherein the adhesive layer is colorless and transparent.

17. The heat transfer film of claim 16, wherein a material of the adhesive layer is UV curable adhesive or heat curable adhesive.

18. The heat transfer film of claim 15, wherein the hard coating film is a removable adhesive tape.
